(19) United States
(12) Patent Application Publication
(10) Pub. No.: US 2021/0105976 A1
(43) Pub. Date: Apr. 15, 2021

(54) UNDERCOLLAR FOR AN ANIMAL

(71) Applicant: Tracy Young, Wellington, FL (US)

(72) Inventor: Tracy Young, Wellington, FL (US)

(21) Appl. No.: 17/070,691

(22) Filed: Oct. 14, 2020

Related U.S. Application Data
(60) Provisional application No. 62/914,614, filed on Oct. 14, 2019.

(51) Int. Cl. A01K 27/00

(52) U.S. Cl. CPC A01K 27/001

(57) ABSTRACT

Disclosed herein is an undercollar for an animal, in accordance with some embodiments. Accordingly, the undercollar may include a collar body disposable around at least one part of a body of an animal. Further, the collar body extends between a first end of the collar body and a second end of the collar body. Further, the collar body may include at least one fastening element. Further, the undercollar may include at least one identification tag assembly coupled with the collar body. Further, the at least one identification tag assembly may include a panel may include a viewing portion. Further, the panel may be peripherally attached in at least one part to the outer surface forming an interior space and an opening. Further, the at least one identification tag assembly may include at least one identification tag removably disposed in the interior space through the opening.

The current application claims a priority to the U.S. Provisional Patent application Ser. No. 62/914,614 filed on Oct. 14, 2019.

### FIELD OF THE INVENTION

Generally, the present disclosure relates to the field of pet accessories. More specifically, the present disclosure relates to an undercollar for an animal.

### BACKGROUND OF THE INVENTION

Taking care of pets requires dedication and consistent attention. Furthermore, pets become an integral part of one's family and as such most pet owners get deeply attached to the pet. Unfortunately, it is not uncommon for pets to get lost. The unfortunate event of losing a pet can be a traumatic experience. Traditional leashes and harnesses are designed to provide a physical and psychological barrier between the handler and the animal. A common problem with these types of leashes, and harnesses, is the way they transfer the force applied by the user. Besides, when the animal is at home, or in a relaxed state, the collars and leashes commonly used can be uncomfortable, and restrictive to the animal. While identification tags are usually attached to the collar, if the owner removes the collar when the animal is at home, the animal does not have any other type of identification. The lack of identification is a major issue if the animal is lost. Alternatively, an identification chip may be installed under the animal's skin with a unique identification number. If the animal is found and taken to a specialized clinic the staff may use reading equipment to decipher the chip and contact the owner; however, unless someone brings the animal to a veterinarian the chip cannot be identified or read directly. Some pet owners choose to remove the conventional collar once the animal is in a space where it can roam freely. A conventional collar may be restrictive, and the hard materials typically used to manufacture these types of collar can be noisy and uncomfortable for both the pet and the owner. There is also an all too common, well-known anxiety that plagues nearly every pet owner around the globe; an escaped pet without a collar or ID around their neck. Most pet owners have been there, their hearts pop out of their chest, the world starts to spin, and the pet owners fall into a state of panic, worry, and unrest until the pets are returned. It's known this story has a 50/50 chance of ending badly. Some owners may be lucky but not everyone may be lucky. Also, 1 in 3 of the pets (or beloved four-legged family members) will get lost or go on a mission, and 20% of them will never find their way back home. In fact, according to the American Society for the Prevention of Cruelty to Animals (ASPCA), 80% of pet parents believe pet ID tags are crucially important but only 33% report that their pet always wears one. At least 67% of the pet owners (with only the best of intentions—the pet's comfort) may remove their bulky, noisy collars while they are relaxing inside, or in a confined area, never thinking that the pets may bolt through an open door or gate should one open unexpectedly. This conundrum is not lessened by dedication to trying. Further, the pet owners buy GPS collars and think, “ahh, ok, pets will always be trackable”, but what happened if the battery dies or they roam beyond a cell tower? Those microchips run the risk of old hardware that fails to read new data and vice versa. Technology is a wonderful thing, but it is not fail-proof and is dependent on things humans and pets cannot always control. The bottom line remains that pets without ID are the number one reason why 20% of the pets never find their way back to their pet owners.

Therefore, there is a need for an undercollar for an animal that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an undercollar for an animal, in accordance with some embodiments. Accordingly, the undercollar may include a collar body disposable around at least one part of a body of an animal. Further, the collar body extends between a first end of the collar body and a second end of the collar body. Further, the collar body may include at least one fastening element. Further, a first part of the at least one fastening element may be comprised in a first portion of the collar body. Further, a second part of the at least one fastening element may be comprised in a second portion of the collar body. Further, the first part of the at least one fastening element may be configured to be fastened to the second part of the at least one fastening element for attaching the first portion to the second portion. Further, the collar body forms a loop based on the attaching. Further, the collar body may include an inner surface and an outer surface. Further, the collar body may include at least one material. Further, the at least one material provides comfort to the at least one part of the body of the animal. Further, the collar body does not comprise a component configured to be attached to a leash. Further, the undercollar may include at least one identification tag assembly coupled with the collar body. Further, the at least one identification tag assembly may include a panel including a viewing portion. Further, the panel may be peripherally attached in at least one part to the outer surface forming an interior space and an opening. Further, the at least one identification tag assembly may include at least one identification tag removably disposed in the interior space through the opening. Further, at least one portion of the at least one identification tag juxtaposes the viewing portion. Further, the at least one portion may be viewable through the viewing portion.

Further disclosed herein is an undercollar for an animal, in accordance with some embodiments. Accordingly, the undercollar may include a collar body disposable around at least one part of a body of an animal. Further, the collar body extends between a first end of the collar body and a second end of the collar body. Further, the collar body may include at least one fastening element. Further, a first part of the at least one fastening element may be comprised in a first portion of the collar body. Further, a second part of the at least one fastening element may be comprised in a second portion of the collar body. Further, the first part of the at least one fastening element may be configured to be fastened to the second part of the at least one fastening element for attaching the first portion to the second portion. Further, the collar body forms a loop based on the attaching. Further, the collar body may include an inner surface and an outer surface. Further, the collar body may include at least one material. Further, the at least one material provides comfort to the at least one part of the body of the animal. Further, the collar body does not comprise a component configured to be attached to a leash. Further, the undercollar may include at least one identification tag assembly coupled with the collar body. Further, the at least one identification tag assembly may include a panel including include a viewing portion. Further, the panel may be peripherally attached in at least one part to the outer surface forming an interior space and an opening. Further, the at least one identification tag assembly may include at least one identification tag removably disposed in the interior space through the opening. Further, at least one portion of the at least one identification tag juxtaposes the viewing portion. Further, the at least one portion may be viewable through the viewing portion. Further, the undercollar may include at least one adjusting mechanism coupled with the collar body. Further, the at least one adjusting mechanism may be configured for foldably extending at least one portion of the collar body based on at least one action receivable by the at least one adjusting mechanism. Further, the at least one adjusting mechanism may be configured for modifying a length of the collar body defined between the first end and the second end based on the foldably extending.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of an undercollar for an animal, in accordance with some embodiments.

FIG. 2 is a bottom view of the undercollar for the animal, in accordance with some embodiments.

FIG. 3 is a front view of the at least one adjusting mechanism, in accordance with some embodiments.

FIG. 4 is a front view of the undercollar with the at least one adjusting mechanism, in accordance with some embodiments.

FIG. 5 is a top view of a first rubber article with a plurality of identification tags, in accordance with some embodiments.

FIG. 6 is a front view of the first rubber article without the plurality of identification tags, in accordance with some embodiments.

FIG. 7 is a front view of the first rubber piece, in accordance with some embodiments.

FIG. 8 is a side view of the first rubber piece and the second rubber piece, in accordance with some embodiments.

FIG. 9 is a front view of the second rubber piece, in accordance with some embodiments.

FIG. 10 is a side view of the second rubber piece, in accordance with some embodiments.

FIG. 11 is a side view of the third rubber piece of the first rubber article, in accordance with some embodiments.

FIG. 12 is a side view of the first rubber piece, the second rubber piece, and the third rubber piece, in accordance with some embodiments.

FIG. 13 is a bottom view of the third rubber piece, in accordance with some embodiments.

FIG. 14 is a top view of a second rubber article, in accordance with some embodiments.

FIG. 15 is a bottom view of the second rubber article, in accordance with some embodiments.

FIG. 16 is a side view of the second rubber article, in accordance with some embodiments.

FIG. 17 is a front view of the belt keeper, in accordance with some embodiments.

FIG. 18 is a front view of an undercollar for an animal, in accordance with some embodiments.

FIG. 19 is a front view of an interlocking clasp of the attachment mechanism, in accordance with some embodiments

FIG. 20 is a rear view of the interlocking clasp of the attachment mechanism, in accordance with some embodiments.

FIG. 21 is a front view of an animal wearing an undercollar, in accordance with some embodiments.

FIG. 22 is a left side view of the animal wearing the undercollar, in accordance with some embodiments.

FIG. 23 is a front view of an undercollar, in accordance with some embodiments.

FIG. 24 is a front view of the undercollar, in accordance with some embodiments.

FIG. 25 is a front top right side perspective view of the undercollar, in accordance with some embodiments.

FIG. 26 is a front top right side perspective view of the undercollar, in accordance with some embodiments.

FIG. 27 is a front top right side perspective view of the undercollar, in accordance with some embodiments.

FIG. 28 is a front bottom perspective view of the undercollar, in accordance with some embodiments

FIG. 29 is an undercollar kit for the animal, in accordance with some embodiments.

FIG. 30 is a front view of an identification tag of an undercollar, in accordance with some embodiments.

FIG. 31 is a front view of a first identification tag of the undercollar, in accordance with some embodiments.

FIG. 32 is a front top perspective view of an undercollar for an animal, in accordance with some embodiments.

FIG. 33 is a rear top view of the undercollar, in accordance with some embodiments.

FIG. 34 is a right side view of the undercollar, in accordance with some embodiments.

FIG. 35 is a left side view of the undercollar, in accordance with some embodiments.

FIG. 36 is a front view of an undercollar for an animal, in accordance with some embodiments.

FIG. 37 is a rear view of the undercollar, in accordance with some embodiments.

FIG. 38 is an illustration of an online platform consistent with various embodiments of the present disclosure.

FIG. 39 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of an undercollar for an animal, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes an undercollar for an animal. Further, the disclosed collar may be called UnderCollar®. Further, the UnderCollar® may be thoughtfully designed with passion and purpose for the comfort, safety, and protection of pets. Further, the UnderCollar® may assure that pets will never be without ID (Identification). The UnderCollar® may be attached to every pet (or furrie).

Further, the disclosed collar may be simple and uncomplicated. Further, the disclosed collar may include a closure feature. Further, the disclosed collar may include a soft, slip-proof, comfortable collar that the pets may always keep on under a regular day collar with a name and phone number associated with the owner of the pets. Further, the disclosed collar may be driven by a singular purpose; get every beloved pet in an UnderCollar® so they will never be without ID. Further, the disclosed collar may include a registered UnderCollar® QR code. Further, the disclosed collar may ensure to provide love and positivity to the pets. Further, the disclosed collar may help protect the pets by providing them ID's and safe.

Further, the UnderCollar® may be designed to be worn by the pet at all times. Further, the UnderCollar® may be manufactured out of flexible materials that do not constrict or hinder the animal. Furthermore, the disclosed collar may maintain a minimalistic design with an integrated identification label where the user may be able to write their contact information, including but not limited to a phone number, name, and/or address.

Further, the present disclosure describes a comfortable undercollar with integrated identification means, which the pet may wear at all times, even when the animal is in a relaxed state, therefore preventing any discomfort normally associated with conventional collars and leashes.

Further, the disclosed collar may include a collar-designed to be both comfortable and durable that ensures the ID remains on pets at all times. Further, the disclosed collar may be made from soft, pliable, slip-proof banding. Further, the disclosed collar may stretch around the pet's head with no cumbersome buckles or fasteners while remaining roomy enough to never pull, pinch, or cause discomfort. Further, the disclosed collar may be designed to always be on and fit under the everyday leash and harness collars that are taken on and off. Further, upon wearing the disclosed collar by the pet, the pets may not feel the presence of the disclosed collar. Further, the disclosed collar may make both of the pets and the pet owners happy. Further, a sharpie may be used to write the name of the pet and the contact number of the pet owner in permanent ink on the disclosed collar. Further, upon wearing the disclosed collar by the pet, the pet may never be without the ID.

Further, the present disclosure describes an undercollar. Further, the undercollar comprises a main body, an identification tag, and an attachment mechanism. The main body comprises a collar, fabric inserts, and a plurality of reflective edges. The collar resembles a flexible band in shape. Furthermore, the collar is manufactured out of flexible materials. The plurality of reflective insets is positioned perimetrically around the outer edges of the collar. Further, the plurality of reflective inserts may be directly included in the surface of the collar. The plurality of reflective inserts is light activated, making the collar visible even in low visibility conditions. Further, the undercollar aims to increase the safety of the pet by increasing the visibility, as a result, if the pet is lost at night, the high visibility properties of the collar may increase the chances of finding the animal at a faster rate. Further, the collar is manufactured out of flexible stretchy material including but not limited to any type of elastic textile fabric. Furthermore, the fabric insert is positioned on the underside of the collar ensuring the undercollar is comfortable to wear for the pet. In addition, the fabric insert allows the pet owner to easily slip on the undercollar over the head of the animal. Further, the fabric insert may resemble a tape or ribbon. The undercollar may be further adapted for pets of various sizes, and it may also be personalized depending on user preference. In addition, the user has the option to customize the identification tag depending on preference. Further, the identification tag comprises a viewing window, a first rubber piece, a second rubber piece, and a plurality of identification tags. The first rubber piece and the second rubber piece are permanently fastened providing enough support for the viewing window. The collar is positioned between the first rubber piece, and the second rubber piece, fixating the identification tag assembly to the collar. Further, the first rubber piece is stitched to the second rubber piece. Further, other attachment means may be integrated for attaching the first rubber piece and the second rubber piece including but not limited to fasteners, and various adhesives. The viewing window is constructed out of transparent waterproof materials, ensuring the plurality of identity tags is protected from the elements. Further, the plurality of identity tags is constructed out of laminated paper and a variety of other types of identity tags and materials may be integrated. As an example, a quick response (QR) code may be printed onto the identity tag. The QR code may be read using a conventional mobile device, allowing a user to obtain the identity of the pet owner through a secure database. Furthermore, a microchip may also be integrated into the identified tag assembly to provide an additional method of obtaining the personal information of the owner.

Further, the present disclosure describes the usage of a dedicated mobile device application. With the purchase of every collar, the user would receive a unique identifier code, that would activate the QR code when scanned. The identification tag assembly comprises key identifiers including but not limited to, pet name, primary phone number, secondary phone number, address, microchip number, and an optional personalized message. Further, the identification tag assembly is removable from the collar. In addition, a plurality of design features may be integrated into the undercollar allowing users to customize the appearance of the collar based on their own individual preference. Further, the attachment mechanism comprises an interlocking clasp, a plurality of female studs, and a plurality of male studs. The interlocking clasp fastens in a flat plane, in relation to the surface of the collar. Opening and closing the attachment mechanism will not accidentally pinch the animal's neck due to the flat plane design of the locking mechanism. Further, the undercollar may use various clamps to connect one end of the collar to another end. The attachment mechanism of the undercollar enhances the adjustability of the device, allowing the user to tailor the collar individually to the pet. Further, the undercollar comprises a tri-glide adjuster. Various other adjustability mechanisms may be included in the undercollar.

Further, the identification tag assembly may be designed as a U-shaped unibody with the viewing window built-in. Further, the identification tag assembly is permanently fastened to the collar. Further, the undercollar may include an integrated clasp where the collar may be opened at one end. The undercollar features a different attachment method which does not allow the user to open the collar. Further, the user may also place the collar over the head of the animal and is able to adjust it according to the size of the pet.

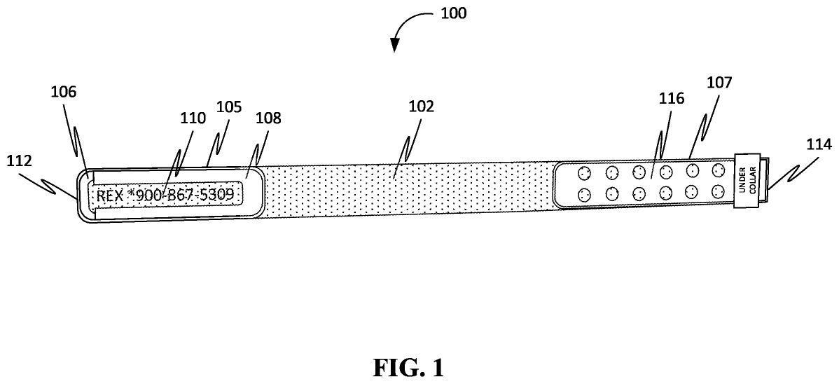

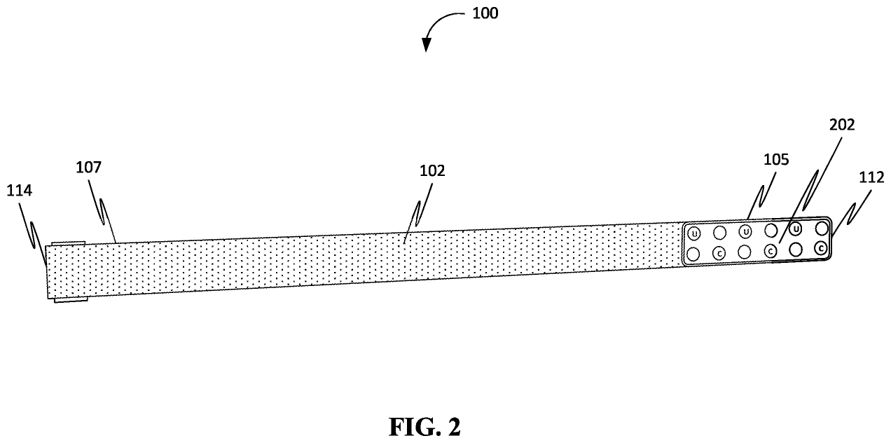

FIG. 1 is a front view of an undercollar 100 for an animal, in accordance with some embodiments. Accordingly, the undercollar 100 may include a collar body 102 disposable around at least one part of a body of an animal. Further, the animal may include at least one pet animal. Further, the at least one pet animal may include a dog, a cat, etc. Further, the at least one part of the body of the animal may include a neck, a back, a leg, etc. Further, the collar body 102 extends between a first end 112 of the collar body 102 and a second end 114 of the collar body 102. Further, the collar body 102 may include at least one fastening element. Further, a first part 202, as shown in FIG. 2, of the at least one fastening element may be comprised in a first portion 105 of the collar body 102. Further, a second part 116 of the at least one fastening element may be comprised in a second portion 107 of the collar body 102. Further, the first part 202 of the at least one fastening element may be configured to be fastened to the second part 116 of the at least one fastening element for attaching the first portion 105 to the second portion 107. Further, the collar body 102 forms a loop based on the attaching of the first portion 105 and the second portion 107. Further, the collar body 102 may include an inner surface and an outer surface. Further, the collar body 102 may include at least one material. Further, the at least one material provides comfort to the at least one part of the body of the animal. Further, the collar body 102 does not comprise a component configured to be attached to a leash. Further, the collar body 102 may be at least one of elongated and flexible. Further, the loop may be a continuous loop.

Further, the undercollar 100 may include at least one identification tag assembly 106 coupled with the collar body 102. Further, the at least one identification tag assembly 106 may include a panel 108. Further, the panel 108 may include a viewing portion. Further, the panel 108 may be peripherally attached in at least one part to the outer surface forming an interior space and an opening.

Further, the at least one identification tag assembly 106 may include at least one identification tag 110 removably disposed in the interior space through the opening. Further, at least one portion of the at least one identification tag 110 juxtaposes the viewing portion. Further, the at least one portion may be viewable through the viewing portion.

Further, in some embodiments, the panel 108 may include a cutaway. Further, the cutaway forms the viewing portion. Further, the at least one portion of the at least one identification tag 110 may be viewable through the cutaway.

Further, in some embodiments, the panel 108 may include a transparent portion forming the viewing portion. Further, the transparent portion may include at least one transparent material.

Further, in some embodiments, the at least one material may include at least one of at least one stretchable material, at least one flexible material, and at least one soft material.

Further, the at least one of the at least one stretchable material, the at least one flexible material, and the at least one soft material provides comfort to the at least one part of the body of the animal.

Further, in some embodiments, the collar body 102 may be configurable for interfacing with a collar disposable around the at least one part of the body of the animal. Further, the collar may include a first component configured to be attached to the leash. Further, the outer surface interacts with an inner collar surface of the collar based on the interfacing. Further, the collar body 102 may be configured for absorbing at least one action receivable on the outer surface of the collar body 102 from the collar. Further, the absorbing of the at least one action provides comfort to the at least one part of the body of the animal. Further, the at least one action comprises a rubbing action, a pressing action, etc.

Further, in some embodiments, the outer surface attaches with the inner collar surface based on the interfacing. Further, the collar body 102 may be configured for preventing a contact between the collar and the at least one part of the body of the animal. Further, the preventing of the contact provides comfort to the at least one part of the body of the animal.

Further, in some embodiments, the collar body 102 may include at least one reflective portion. Further, the at least one reflective portion may include at least one reflective material. Further, the at least one reflective portion may be configured for making the collar body 102 visible by reflecting light.

Further, in some embodiments, the first part 202 of the at least one fastening element may be configured to be detachably fastened to the second part 116 of the at least one fastening element for detachably attaching the first portion 105 to the second portion 107.

Further, in some embodiments, the first part 202 of the at least one fastening element may be configured to be fixedly fastened to the second part 116 of the at least one fastening element for fixedly attaching the first portion 105 to the second portion 107.

Further, in some embodiments, the at least one fastening element may include an attachment mechanism. Further, the attachment mechanism may include at least one male stud and at least one female stud. Further, a male stud of the at least one male stud forms a hook and a female stud of the at least one female stud forms a loop. Further, the female stud may be configured for removably receiving the male stud. Further, the at least one male stud may be disposed on the first end 112 and the at least one female stud may be disposed on the second end 114. Further, the first end 112 may be configured to be detachably attached to the second end 114 based on the removably receiving.

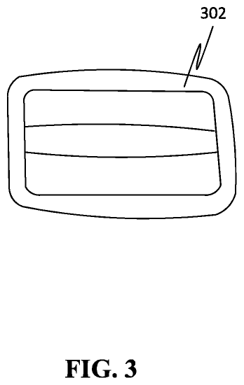

In further embodiments, the undercollar 100 may include at least one adjusting mechanism 302 (as shown in FIG. 3) coupled with the collar body 102. Further, the at least one adjusting mechanism 302 may be configured for foldably extending at least one portion of the collar body 102 based on at least one action receivable by the at least one adjusting mechanism 302. Further, the at least one adjusting mechanism 302 may be configured for modifying a length of the collar body 102 defined between the first end 112 and the second end 114 based on the foldably extending.

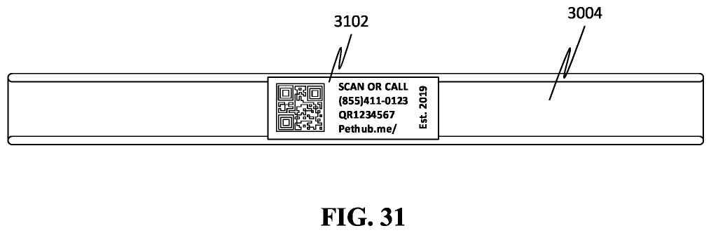

Further, in some embodiments, the at least one identification tag 110 may include a first identification tag (such as the first identification tag 3102, as shown in FIG. 31). Further, the first identification tag may include at least one identifier. Further, the at least one identifier may include a QR code, RFID code, NFC code, etc. Further, the at least one identifier may be non human-readable. Further, the at least one identifier may be unique to the first identification tag. Further, a device may be configurable for interfacing with the first identification tag. Further, the device may be configurable for receiving the at least one identifier from the first identification tag based on the interfacing. Further, the device may be configurable for retrieving at least one information based on the at least one identifier. Further, the device may be configurable for presenting the at least one information based on the retrieving. Further, the at least one information may include animal owner information associated with an animal owner of the animal. Further, the animal owner information may include information such as a name of the animal owner, a contact number of the animal owner, an address of the animal owner, etc.

FIG. 2 is a bottom view of the undercollar 100 for the animal, in accordance with some embodiments.

FIG. 3 is a front view of the at least one adjusting mechanism 302, in accordance with some embodiments.

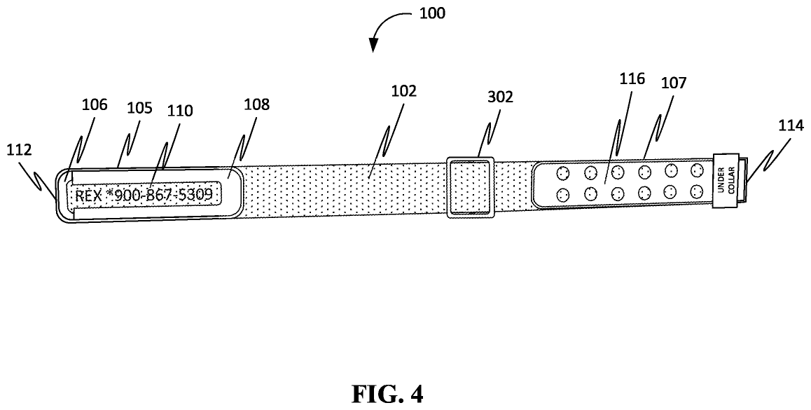

FIG. 4 is a front view of the undercollar 100 with the at least one adjusting mechanism 302, in accordance with some embodiments.

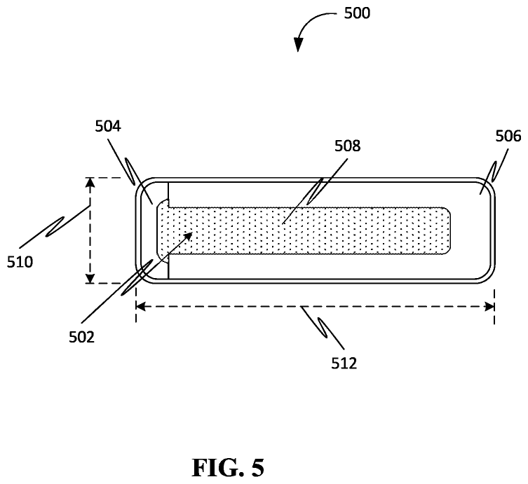

FIG. 5 is a top view of a first rubber article 500 with a plurality of identification tags 508, in accordance with some embodiments. Accordingly, the first rubber article 500 may include a first rubber piece 504, a second rubber piece 506, and a third rubber piece 1102. Further, the second rubber piece 506 may be disposed on a first side of the first rubber piece 504 and the third rubber piece 1102 may be disposed on a second side of the first rubber piece 504. Further, the second rubber piece 506 may include a viewing window 502. Further, the second rubber piece 506 may be cemented to the first rubber piece 504 on a concave dip of the first rubber piece 504. Further, the first rubber piece 504 and the second rubber piece 506 forms an identification tag assembly (such as the at least one identification tag assembly 106). Further, a breadth 510 may be ⅞″. Further, a length 512 may be 3″.

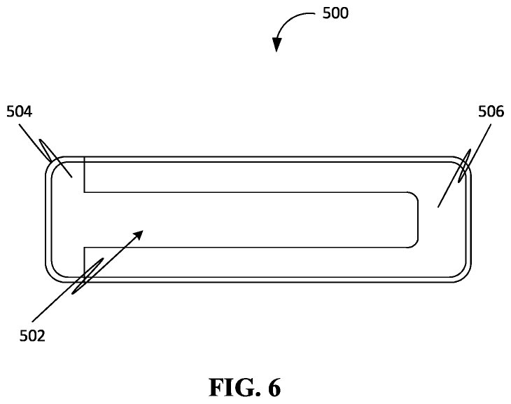

FIG. 6 is a front view of the first rubber article 500 without the plurality of identification tags 508, in accordance with some embodiments

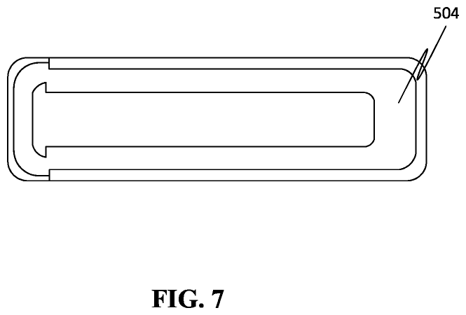

FIG. 7 is a front view of the first rubber piece 504, in accordance with some embodiments.

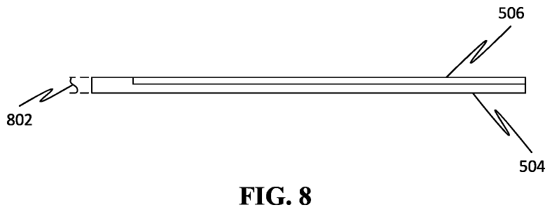

FIG. 8 is a side view of the first rubber piece 504 and the second rubber piece 506, in accordance with some embodiments. Accordingly, a width 802 associated with the first rubber piece 504 and the second rubber piece 506 may be 2 mm.

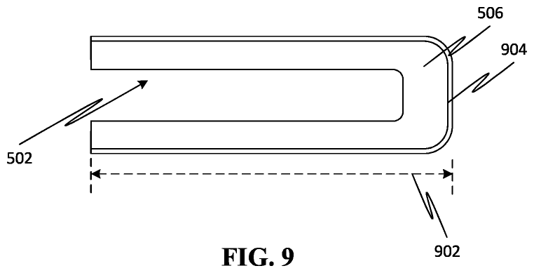

FIG. 9 is a front view of the second rubber piece 506, in accordance with some embodiments. Accordingly, a width 902 may be 2.75 inches. Further, the second rubber piece 506 may include a stitch line 904.

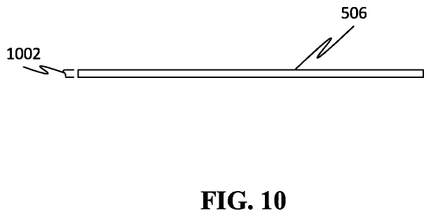

FIG. 10 is a side view of the second rubber piece 506, in accordance with some embodiments. Accordingly, a width 1002 may be 1.5 mm

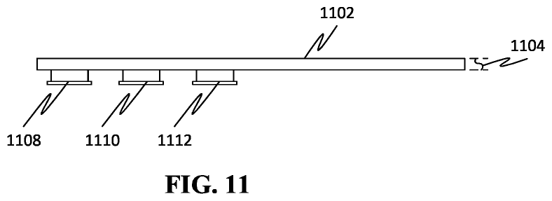

FIG. 11 is a side view of the third rubber piece 1102 of the first rubber article 500, in accordance with some embodiments. Accordingly, the third rubber piece 1102 may be disposed adjacent to the first rubber piece 504. Further, a width 1104 may be 2 mm. Further, the third rubber piece 1102 may include at least one stud (1108-1112 and 1302-1306).

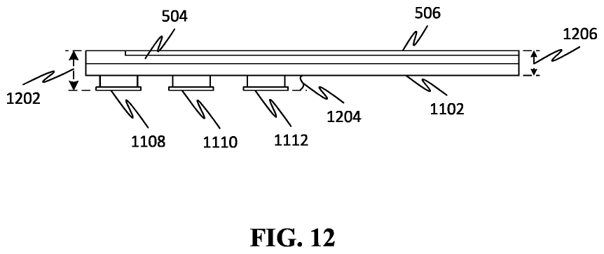

FIG. 12 is a side view of the first rubber piece 504, the second rubber piece 506, and the third rubber piece 1102, in accordance with some embodiments. Accordingly, a width 1202 may be 7 mm. Further, the at least one stud (1108-1112 and 1302-1306) may be associated with a length 1204. Further, the length 1204 may be 3 mm. Further, a width 1206 may be 4 mm.

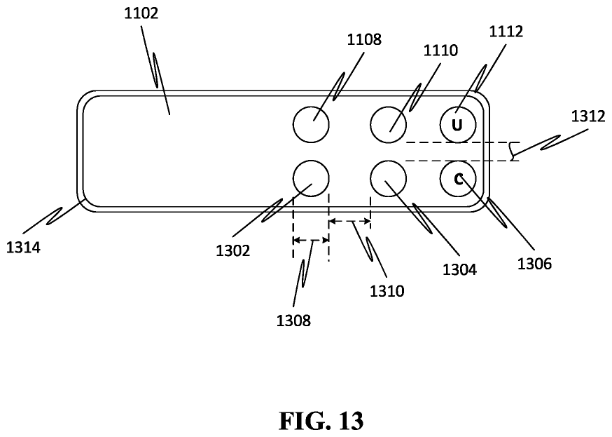

FIG. 13 is a bottom view of the third rubber piece 1102, in accordance with some embodiments. Accordingly, the at least one stud (1108-1112 and 1302-1306) may be associated with a width 1308. Further, the width 1308 may be 5 mm. Further, a width 1310 may be 6.5 mm. Further, a width 1312 may be 3.5 mm. Further, the third rubber piece 1102 may include a stitch line 1314.

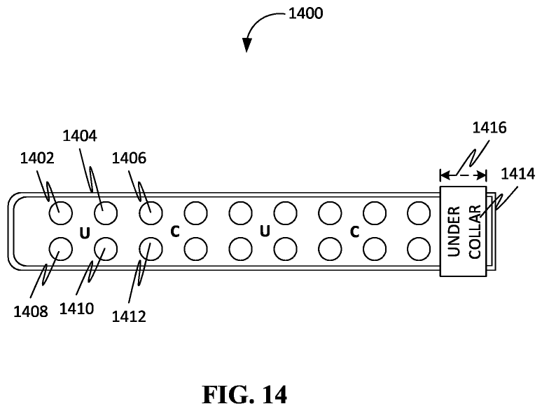

FIG. 14 is a top view of a second rubber article 1400, in accordance with some embodiments. Further, the second rubber article 1400 may include at least one hole 1402-1412 and a belt keeper 1414. Further, the at least one hole 1402-1412 may be configured for receiving the at least one stud (1108-1112 and 1302-1306). Further, a width 1416 may be 13 mm

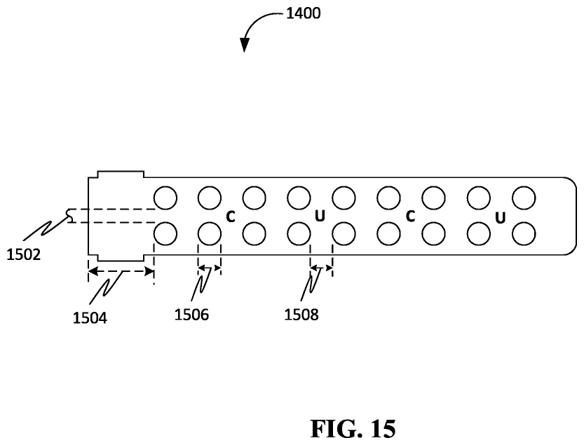

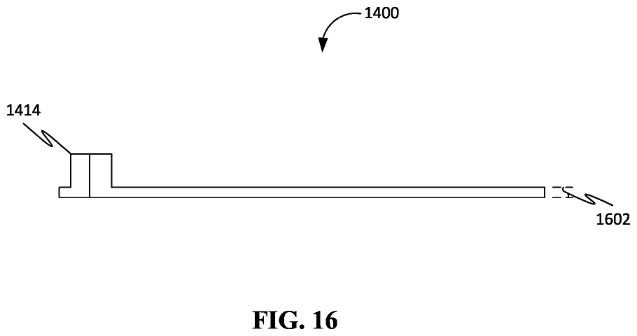

FIG. 15 is a bottom view of the second rubber article 1400, in accordance with some embodiments. Accordingly, a width 1502 may be 3.5 mm. Further, a length 1504 may be 18.7 mm. Further, a width 1506 may be associated with the at least one hole 1402-1412. Further, the width 1506 may be 6.3 mm. Further, a length 1508 may be 6.7 mm FIG. 16 is a side view of the second rubber article 1400, in accordance with some embodiments. Accordingly, a width 1602 may be 3 mm

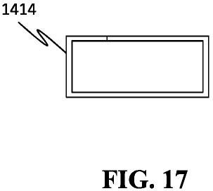

FIG. 17 is a front view of the belt keeper 1414, in accordance with some embodiments. Accordingly, the belt keeper 1414 may include a gauge of 2.5 mm

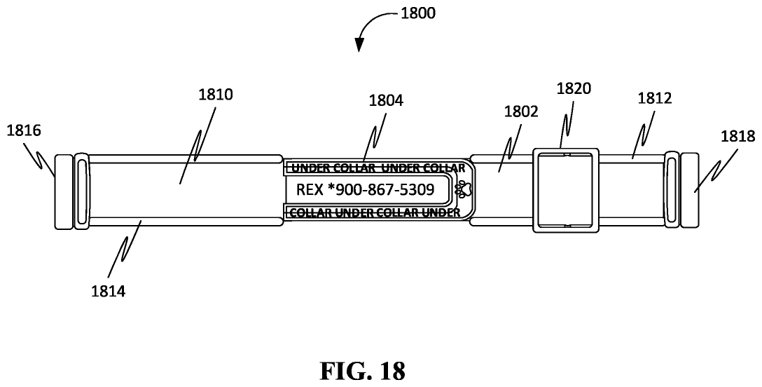

FIG. 18 is a front view of an undercollar 1800 for an animal, in accordance with some embodiments. Accordingly, the undercollar 1800 may include a main body 1802 (such as the collar body 102), an identification tag assembly 1804, and an attachment mechanism (such as the at least one fastening element). Further, the identification tag assembly 1804 (such as the at least one identification tag assembly 106). Further, the main body 1802 may form a collar. Further, the main body 1802 may include a fabric insert 1810, and a plurality of reflective inserts 1812-1814. Further, the plurality of reflective inserts 1812-1814 may include at least one reflective material. Further, the collar may include a flexible band in shape. Further, the collar may be manufactured out of flexible materials (or flexible stretchy fabric) but not limited to any type of elastic textile fabric. Further, the plurality of reflective inserts 1812-1814 may be positioned perimetrically around the outer edges of the collar. Further, the plurality of reflective inserts 1812-1814 may be directly included into a surface of the collar. Further, the plurality of reflective inserts 1812-1814 may be light activated, making the collar visible even in low visibility conditions.

Further, the undercollar 1800 may increase the safety of a pet by increasing the visibility, as a result, if the pet is lost at night, the high visibility properties of the collar may increase the chances of finding the pet at a faster rate. Further, the fabric insert 1810 may be positioned on an underside of the collar ensuring the undercollar 1800 to be comfortably worn by the pet. Further, the fabric insert 1810 may allow a pet owner (or an animal owner) to easily slip on the undercollar 1800 over the head of the pet (or an animal). Further, the fabric insert 1810 may include tape or ribbon. Further, the undercollar 1800 may be adapted for the pets of various sizes. Further, the undercollar 1800 may be personalized depending on a user preference. In addition, the user may customize the identification tag assembly 1804 depending on the user preference.

Further, the attachment mechanism may include an interlocking clasp (such as the interlocking clasp 1900). Further, the interlocking clasp may include a female stud 1816 and a male stud 1818. Further, the female stud 1816 may be attached to a first end of the collar and the male stud 1818 may be attached to a second end of the collar. Further, the interlocking clasp may fasten in a flat plane, in relation to the surface of the collar. Further, opening and closing the attachment mechanism may not accidentally pinch the animal's neck due to the flat plane design of the attachment mechanism. Further, the attachment mechanism may be used to connect the first end of the collar to the second end of the collar. Further, the attachment mechanism may enhance the adjustability of the undercollar 1800 using an adjusting mechanism 1820, allowing the user to tailor the collar individually to the pet. Further, the adjusting mechanism 1820 (such as the at least one adjusting mechanism 302) may include a tri-glide adjuster.

Further, in an embodiment, the attachment mechanism may not allow the user to open the collar. Further, the user may place the collar over the head of the pet (or animal) Further, the user may adjust the collar accordingly to a size of the pet.

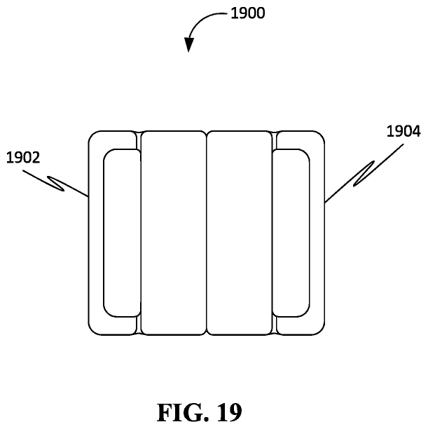

FIG. 19 is a front view of an interlocking clasp 1900 of the attachment mechanism, in accordance with some embodiments. Further, the interlocking clasp 1900 may include a male stud 1902 and a female stud 1904. Further, the female stud 1904 may be configured for receiving the male stud 1902 for detachably fastening the male stud 1902 to the female stud 1904.

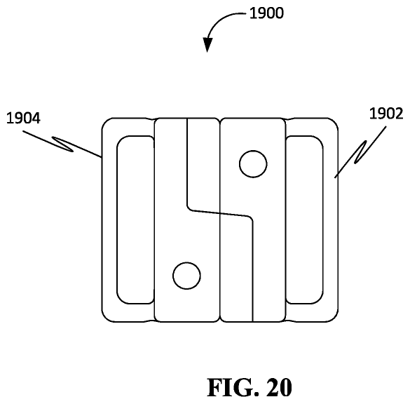

FIG. 20 is a rear view of the interlocking clasp 1900 of the attachment mechanism, in accordance with some embodiments.

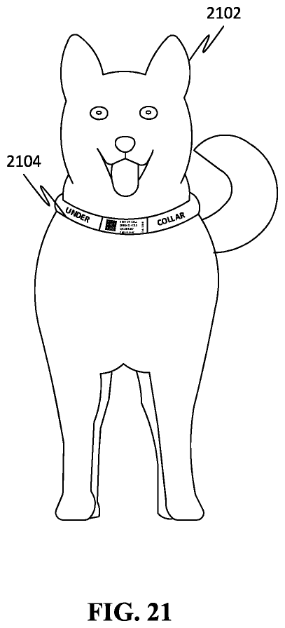

FIG. 21 is a front view of an animal 2102 wearing an undercollar 2104, in accordance with some embodiments. Further, the animal 2102 may include at least one pet animal. Further, the at least one pet animal may include a dog, a cat, etc. Further, the animal 2102 may wear the undercollar 2104 around a neck.

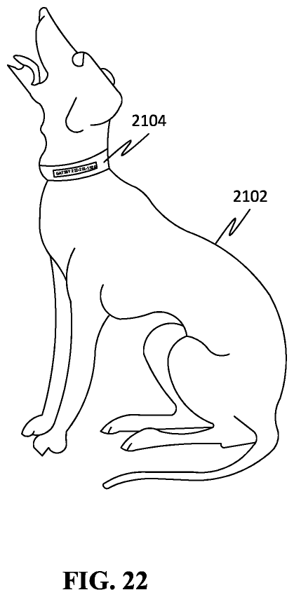

FIG. 22 is a left side view of the animal 2102 wearing the undercollar 2104, in accordance with some embodiments.

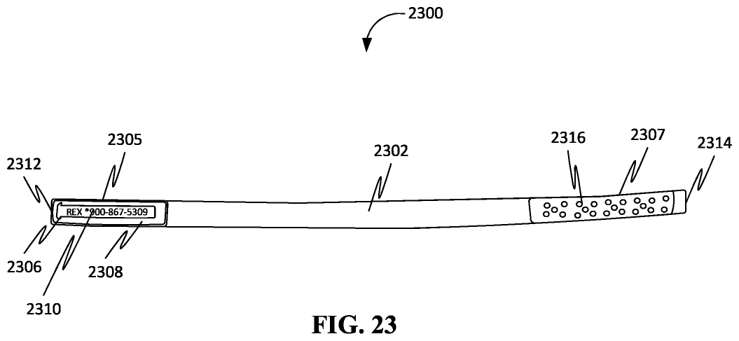

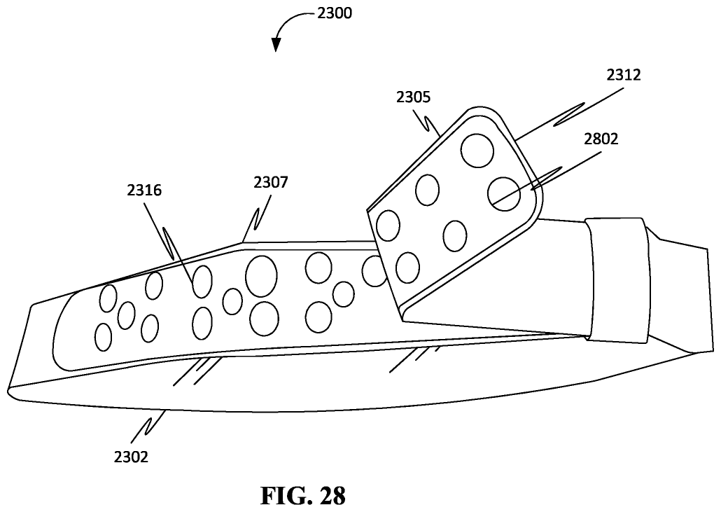

FIG. 23 is a front view of an undercollar 2300, in accordance with some embodiments. Further, the undercollar 2300 may include a collar body 2302 disposable around at least one part of a body of an animal. Further, the animal may include at least one pet animal. Further, the at least one pet animal may include a dog, a cat, etc. Further, the collar body 2302 extends between a first end 2312 of the collar body 2302 and a second end 2314 of the collar body 2302. Further, the collar body 2302 may include at least one fastening element. Further, a first part 2802, as shown in FIG. 28, of the at least one fastening element may be comprised in a first portion 2305 of the collar body 2302. Further, a second part 2316 of the at least one fastening element may be comprised in a second portion 2307 of the collar body 2302. Further, the first part 2802 of the at least one fastening element may be configured to be fastened to the second part 2316 of the at least one fastening element for attaching the first portion 2305 to the second portion 2307. Further, the collar body 2302 forms a loop based on the attaching of the first portion 2305 and the second portion 2307. Further, the undercollar 2300 may include at least one identification tag assembly 2306 coupled with the collar body 2302. Further, the at least one identification tag assembly 2306 may include a panel 2308. Further, the panel 2308 may include a viewing portion. Further, the at least one identification tag assembly 2306 may include at least one identification tag 2310 removably disposed in an interior space through an opening.

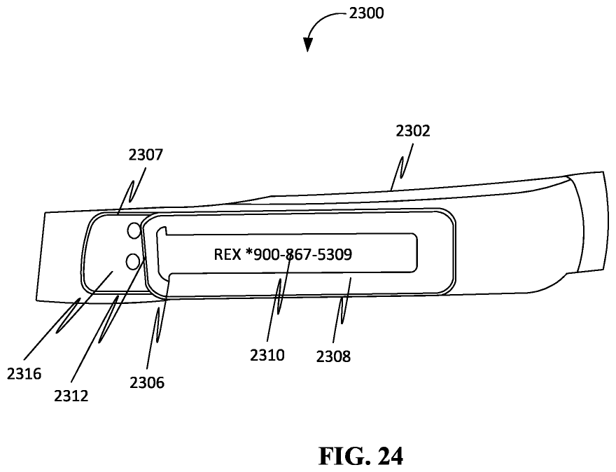

FIG. 24 is a front view of the undercollar 2300, in accordance with some embodiments.

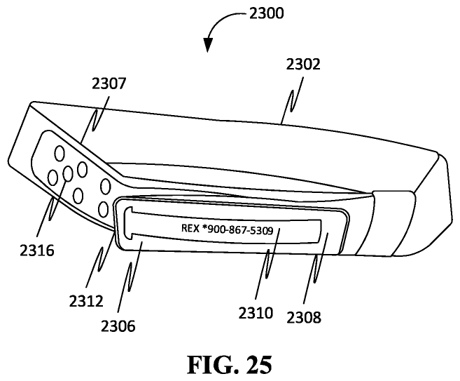

FIG. 25 is a front top right side perspective view of the undercollar 2300, in accordance with some embodiments.

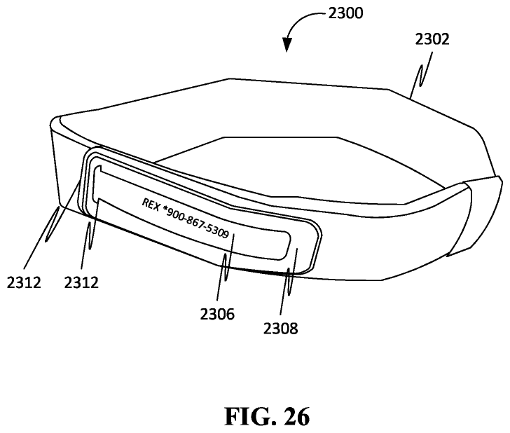

FIG. 26 is a front top right side perspective view of the undercollar 2300, in accordance with some embodiments.

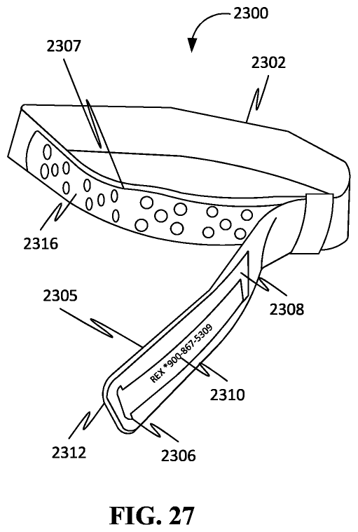

FIG. 27 is a front top right side perspective view of the undercollar 2300, in accordance with some embodiments.

FIG. 28 is a front bottom perspective view of the undercollar 2300, in accordance with some embodiments.

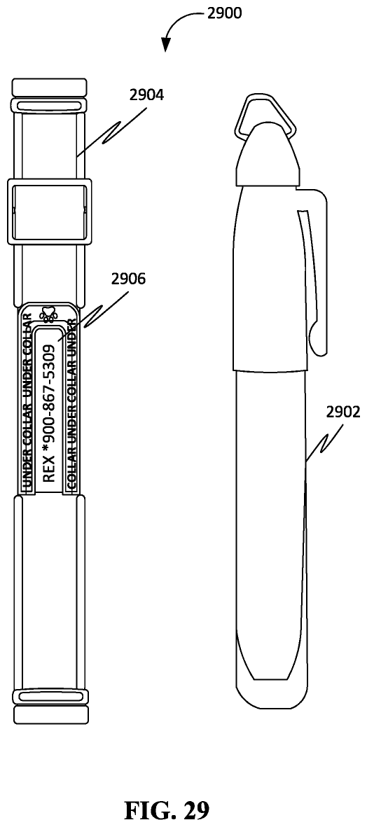

FIG. 29 is an undercollar kit 2900 for the animal, in accordance with some embodiments. Accordingly, the undercollar kit 2900 may include a sharpie 2902 and an undercollar 2904. Further, the sharpie 2902 may be used for writing an identifier including a name of the animal and a contact number of an animal owner on an identification tag 2906 of the undercollar 2904 in permanent ink. Further, the identifier may be waterproof. Further, the identifier may not be damaged by external natural

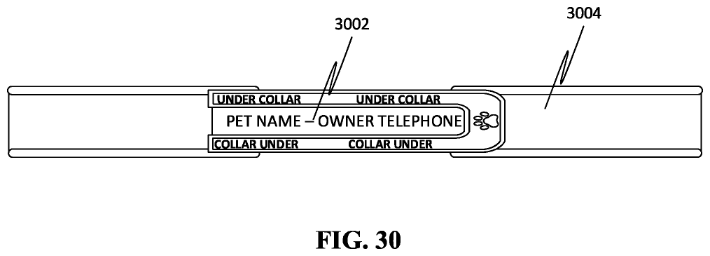

FIG. 30 is a front view of an identification tag 3002 of an undercollar 3004, in accordance with some embodiments. Further, the identification tag 3002 may include an identifier. Further, the identifier may be human readable. Further, the identifier may include information associated with an animal owner of animal. Further, the information may include a name of the animal and a name of the animal owner.

FIG. 31 is a front view of a first identification tag 3102 of the undercollar 3004, in accordance with some embodiments. Accordingly, the first identification tag 3102 may include an identifier. Further, the identifier may be non human readable. Further, the identifier may include a QR code associated with the animal owner.

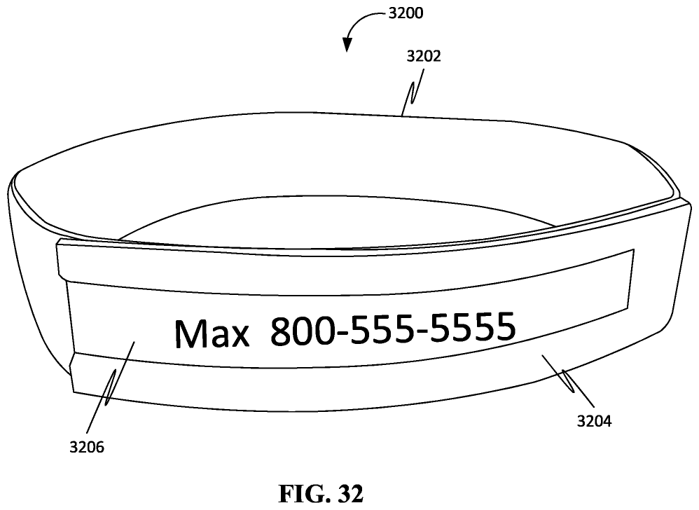

FIG. 32 is a front top perspective view of an undercollar 3200 for an animal, in accordance with some embodiments. Further, the undercollar 3200 may include a collar body 3202 and at least one identification tag assembly 3204. Further, a first portion of the collar body 3202 may be fixedly attached to a second portion of the collar body 3202 forming a loop. Further, the at least one identification tag assembly 3204 may include at least one identification tag 3206. Further, the at least one identification tag 3206 may include a human readable identifier.

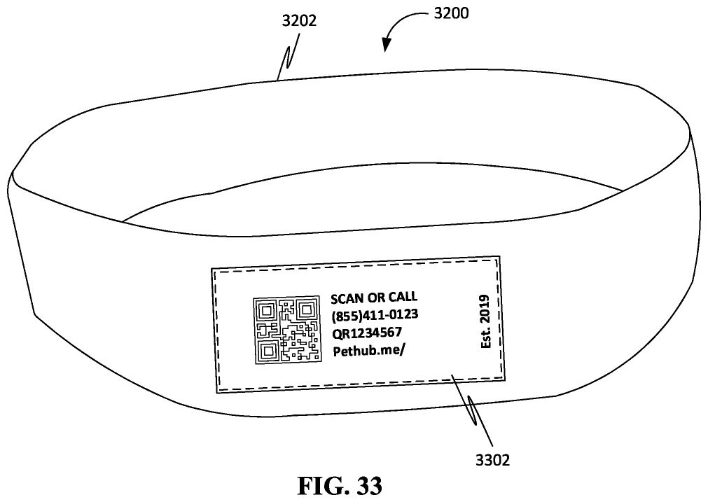

FIG. 33 is a rear top view of the undercollar 3200, in accordance with some embodiments. Further, the at least one identification tag 3206 may include a first identification tag 3302. Further, the first identification tag 3302 may include a non human readable identifier. Further, the non human readable identifier may be computer readable identifier.

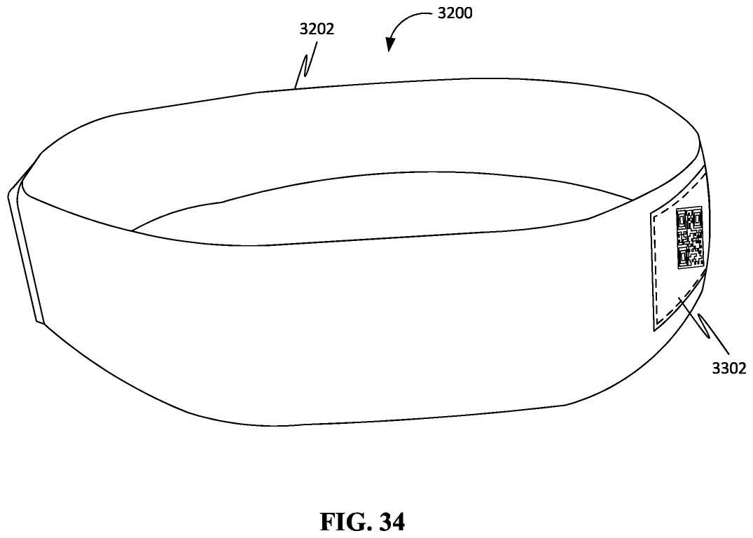

FIG. 34 is a right side view of the undercollar 3200, in accordance with some embodiments.

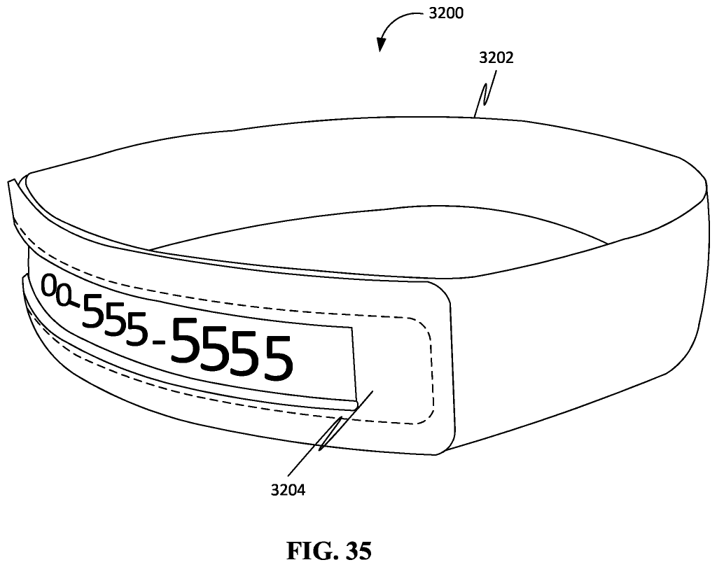

FIG. 35 is a left side view of the undercollar 3200, in accordance with some embodiments.

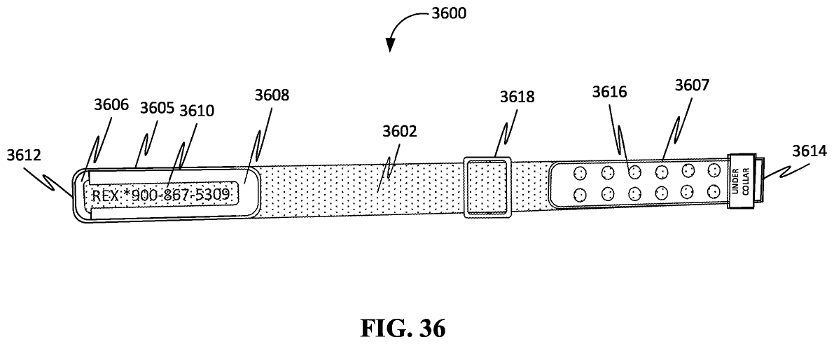

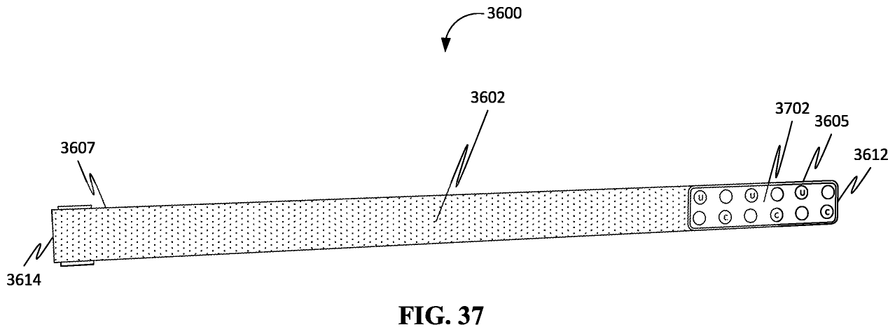

FIG. 36 is a front view of an undercollar 3600 for an animal, in accordance with some embodiments. Accordingly, the undercollar 3600 may include a collar body 3602 disposable around at least one part of a body of an animal. Further, the collar body 3602 extends between a first end 3612 of the collar body 3602 and a second end 3614 of the collar body 3602. Further, the collar body 3602 may include at least one fastening element. Further, a first part 3702, as shown in FIG. 37, of the at least one fastening element may be comprised in a first portion 3605 of the collar body 3602. Further, a second part 3616 of the at least one fastening element may be comprised in a second portion 3607 of the collar body 3602. Further, the first part 3702 of the at least one fastening element may be configured to be fastened to the second part 3616 of the at least one fastening element for attaching the first portion 3605 to the second portion 3607. Further, the collar body 3602 forms a loop based on the attaching. Further, the collar body 3602 may include an inner surface and an outer surface. Further, the collar body 3602 may include at least one material. Further, the at least one material provides comfort to the at least one part of the body of the animal. Further, the collar body 3602 does not comprise a component configured to be attached to a leash. Further, the undercollar 3600 may include at least one identification tag assembly 3606 coupled with the collar body 3602. Further, the at least one identification tag assembly 3606 may include a panel 3608. Further, the panel 3608 may include a viewing portion. Further, the panel 3608 may be peripherally attached in at least one part to the outer surface forming an interior space and an opening. Further, the at least one identification tag assembly 3606 may include at least one identification tag 3610 removably disposed in the interior space through the opening. Further, at least one portion of the at least one identification tag 3610 juxtaposes the viewing portion. Further, the at least one portion may be viewable through the viewing portion.

Further, the undercollar 3600 may include at least one adjusting mechanism 3618 coupled with the collar body 3602. Further, the at least one adjusting mechanism 3618 may be configured for foldably extending at least one portion of the collar body 3602 based on at least one action receivable by the at least one adjusting mechanism 3618. Further, the at least one adjusting mechanism 3618 may be configured for modifying a length of the collar body 3602 defined between the first end 3612 and the second end 3614 based on the foldably extending.

Further, in some embodiments, the panel 3608 may include a cutaway. Further, the cutaway forms the viewing portion. Further, the at least one portion of the at least one identification tag 3610 may be viewable through the cutaway.

Further, in some embodiments, the panel 3608 may include a transparent portion forming the viewing portion. Further, the transparent portion may include at least one transparent material.

Further, in some embodiments, the at least one material may include at least one of at least one stretchable material, at least one flexible material, and at least one soft material.

Further, the at least one of the at least one stretchable material, the at least one flexible material, and the at least one soft material provides comfort to the at least one part of the body of the animal.

Further, in some embodiments, the collar body 3602 may include at least one reflective portion (such as the plurality of reflective inserts 1812-1814). Further, the at least one reflective portion may include at least one reflective material. Further, the at least one reflective portion may be configured for making the collar body 3602 visible by reflecting light.

Further, in some embodiments, the first part 3702 of the at least one fastening element may be configured to be detachably fastened to the second part 3616 of the at least one fastening element for detachably attaching the first portion 3605 to the second portion 3607.

Further, in some embodiments, the first part 3702 of the at least one fastening element may be configured to be fixedly fastened to the second part 3616 of the at least one fastening element for fixedly attaching the first portion 3605 to the second portion 3607.

Further, in some embodiments, the at least one fastening element may include an attachment mechanism. Further, the attachment mechanism may include at least one male stud and at least one female stud. Further, a male stud of the at least one male stud forms a hook and a female stud of the at least one female stud forms a loop. Further, the female stud may be configured for removably receiving the male stud. Further, the at least one male stud may be disposed on the first end 3612 and the at least one female stud may be disposed on the second end 3614. Further, the first end 3612 may be configured to be detachably fastened to the second end 3614 based on the removably receiving.

FIG. 37 is a rear view of the undercollar 3600, in accordance with some embodiments.

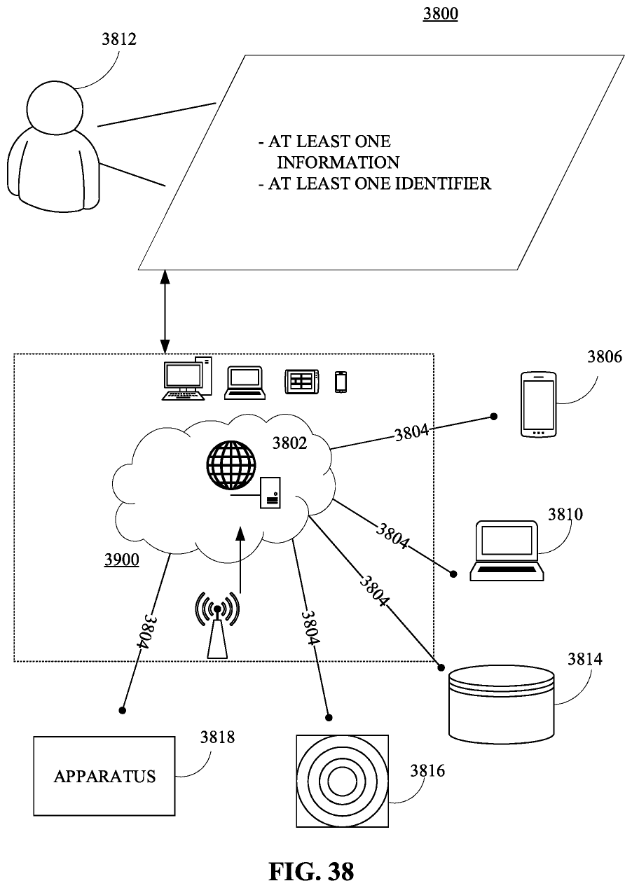

FIG. 38 is an illustration of an online platform 3800 consistent with various embodiments of the present disclosure. By way of non-limiting example, the online platform 3800 to facilitate undercollar for an animal may be hosted on a centralized server 3802, such as, for example, a cloud computing service. The centralized server 3802 may communicate with other network entities, such as, for example, a mobile device 3806 (such as a smartphone, a laptop, a tablet computer etc.), other electronic devices 3810 (such as desktop computers, server computers etc.), databases 3814, sensors 3816, and an apparatus 3818 (such as the undercollar 100, the undercollar 3600, etc.) over a communication network 3804, such as, but not limited to, the Internet. Further, users of the online platform 3800 may include relevant parties such as, but not limited to, end-users, administrators, service providers, service consumers and so on. Accordingly, in some instances, electronic devices operated by the one or more relevant parties may be in communication with the platform.

A user 3812, such as the one or more relevant parties, may access online platform 3800 through a web based software application or browser. The web based software application may be embodied as, for example, but not be limited to, a website, a web application, a desktop application, and a mobile application compatible with a computing device 3900.

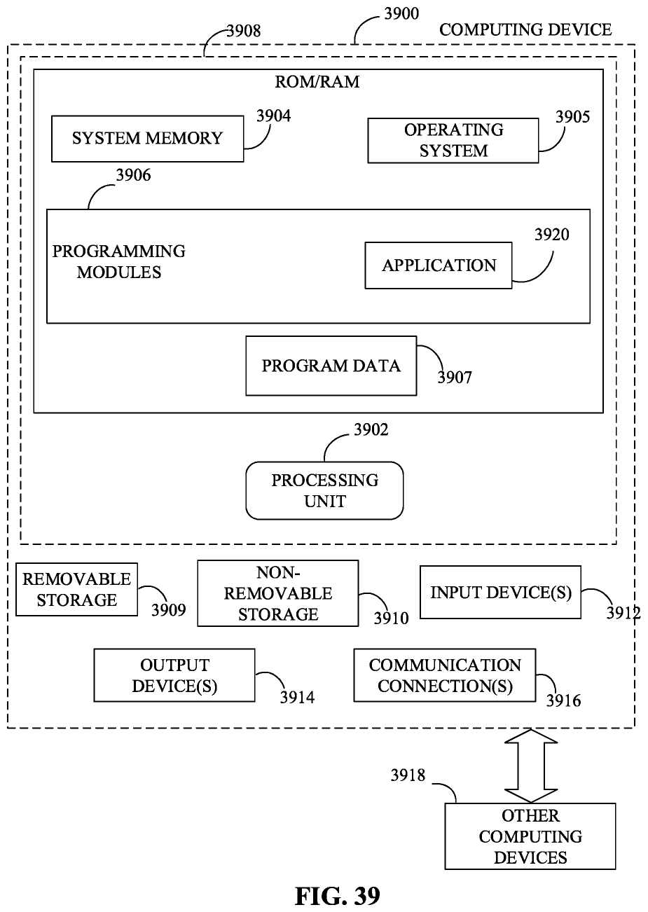

With reference to FIG. 39, a system consistent with an embodiment of the disclosure may include a computing device or cloud service, such as computing device 3900. In a basic configuration, computing device 3900 may include at least one processing unit 3902 and a system memory 3904. Depending on the configuration and type of computing device, system memory 3904 may comprise, but is not limited to, volatile (e.g. random-access memory (RAM)), non-volatile (e.g. read-only memory (ROM)), flash memory, or any combination. System memory 3904 may include operating system 3905, one or more programming modules 3906, and may include a program data 3907. Operating system 3905, for example, may be suitable for controlling computing device 3900's operation. In one embodiment, programming modules 3906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 39 by those components within a dashed line 3908.

Computing device 3900 may have additional features or functionality. For example, computing device 3900 may also include additional data storage devices (removable and/or non-removable) such as, for example, magnetic disks, optical disks, or tape. Such additional storage is illustrated in FIG. 39 by a removable storage 3909 and a non-removable storage 3910. Computer storage media may include volatile and non-volatile, removable and non-removable media implemented in any method or technology for storage of information, such as computer-readable instructions, data structures, program modules, or other data. System memory 3904, removable storage 3909, and non-removable storage 3910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3900. Any such computer storage media may be part of device 3900. Computing device 3900 may also have input device(s) 3912 such as a keyboard, a mouse, a pen, a sound input device, a touch input device, a location sensor, a camera, a biometric sensor, etc. Output device(s) 3914 such as a display, speakers, a printer, etc. may also be included. The aforementioned devices are examples and others may be used.

Computing device 3900 may also contain a communication connection 3916 that may allow device 3900 to communicate with other computing devices 3918, such as over a network in a distributed computing environment, for example, an intranet or the Internet. Communication connection 3916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3904, including operating system 3905. While executing on processing unit 3902, programming modules 3906 (e.g., application 3920) may perform processes including, for example, one or more stages of methods, algorithms, systems, applications, servers, databases as described above. The aforementioned process is an example, and processing unit 3902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An undercollar for an animal comprising:
a collar body disposable around at least one part of a body of an animal, wherein the collar body extends between a first end of the collar body and a second end of the collar body, wherein the collar body comprises at least one fastening element, wherein a first part of the at least one fastening element is comprised in a first portion of the collar body, wherein a second part of the at least one fastening element is comprised in a second portion of the collar body, wherein the first part of the at least one fastening element is configured to be fastened to the second part of the at least one fastening element for attaching the first portion to the second portion, wherein the collar body forms a loop based on the attaching of the first portion to the second portion, wherein the collar body comprises an inner surface and an outer surface, wherein the collar body comprises at least one material, wherein the at least one material provides comfort to the at least one part of the body of the animal, wherein the collar body does not comprise a component configured to be attached to a leash; and
at least one identification tag assembly coupled with the collar body, wherein the at least one identification tag assembly comprises:
a panel comprising a viewing portion, wherein the panel is peripherally attached in at least one part to the outer surface forming an interior space and an opening; and
at least one identification tag removably disposed in the interior space through the opening, wherein at least one portion of the at least one identification tag juxtaposes the viewing portion, wherein the at least one portion is viewable through the viewing portion.

2. The undercollar of claim 1, wherein the panel comprises a cutaway, wherein the cutaway forms the viewing portion, wherein the at least one portion of the at least one identification tag is viewable through the cutaway.

3. The undercollar of claim 1, wherein the panel comprises a transparent portion forming the viewing portion, wherein the transparent portion comprises at least one transparent material.

4. The undercollar of claim 1, wherein the at least one material comprises at least one of at least one stretchable material, at least one flexible material, and at least one soft material, wherein the at least one of the at least one stretchable material, the at least one flexible material, and the at least one soft material provides comfort to the at least one part of the body of the animal.

5. The undercollar of claim 1, wherein the collar body is configurable for interfacing with a collar disposable around the at least one part of the body of the animal, wherein the collar comprises a first component configured to be attached to the leash, wherein the outer surface interacts with an inner collar surface of the collar based on the interfacing, wherein the collar body is configured for absorbing at least one action receivable on the outer surface of the collar body from the collar, wherein the absorbing of the at least one action provides comfort to the at least one part of the body of the animal.

6. The undercollar of claim 5, wherein the outer surface attaches with the inner collar surface based on the interfacing, wherein the collar body is configured for preventing a contact between the collar and the at least one part of the body of the animal, wherein the preventing of the contact provides comfort to the at least one part of the body of the animal.

7. The undercollar of claim 1, wherein the collar body comprises at least one reflective portion, wherein the at least one reflective portion comprises at least one reflective material, wherein the at least one reflective portion is configured for making the collar body visible by reflecting light.

8. The undercollar of claim 1, wherein the first part of the at least one fastening element is configured to be detachably fastened to the second part of the at least one fastening element for detachably attaching the first portion to the second portion.

9. The undercollar of claim 1, wherein the first part of the at least one fastening element is configured to be fixedly fastened to the second part of the at least one fastening element for fixedly attaching the first portion to the second portion.

10. The undercollar of claim 1, wherein the at least one fastening element comprises an attachment mechanism, wherein the attachment mechanism comprises at least one male stud and at least one female stud, wherein a male stud of the at least one male stud forms a hook and a female stud of the at least one female stud forms a loop, wherein the female stud is configured for removably receiving the male stud, wherein the at least one male stud is disposed on the first end and the at least one female stud is disposed on the second end, wherein the first end is configured to be detachably attached to the second end based on the removably receiving.

11. The undercollar of claim 1 further comprising at least one adjusting mechanism coupled with the collar body, wherein the at least one adjusting mechanism is configured for foldably extending at least one portion of the collar body based on at least one action receivable by the at least one adjusting mechanism, wherein the at least one adjusting mechanism is configured for modifying a length of the collar body defined between the first end and the second end based on the foldably extending.

12. The undercollar of claim 1, wherein the at least one identification tag comprises a first identification tag, wherein the first identification tag comprises at least one identifier, wherein the at least one identifier is non human-readable, wherein the at least one identifier is unique to the first identification tag, wherein a device is configurable for:
interfacing with the first identification tag;
receiving the at least one identifier from the first identification tag based on the interfacing;
retrieving at least one information based on the at least one identifier; and
presenting the at least one information based on the retrieving.

13. An undercollar for an animal comprising:
a collar body disposable around at least one part of a body of an animal, wherein the collar body extends between a first end of the collar body and a second end of the collar body, wherein the collar body comprises at least one fastening element, wherein a first part of the at least one fastening element is comprised in a first portion of the collar body, wherein a second part of the at least one fastening element is comprised in a second portion of the collar body, wherein the first part of the at least one fastening element is configured to be fastened to the second part of the at least one fastening element for attaching the first portion to the second portion, wherein the collar body forms a loop based on the attaching of the first portion to the second portion, wherein the collar body comprises an inner surface and an outer surface, wherein the collar body comprises at least one material, wherein the at least one material provides comfort to the at least one part of the body of the animal, wherein the collar body does not comprise a component configured to be attached to a leash;
at least one identification tag assembly coupled with the collar body, wherein the at least one identification tag assembly comprises:
a panel comprising a viewing portion, wherein the panel is peripherally attached in at least one part to the outer surface forming an interior space and an opening; and
at least one identification tag removably disposed in the interior space through the opening, wherein at least one portion of the at least one identification tag juxtaposes the viewing portion, wherein the at least one portion is viewable through the viewing portion; and
at least one adjusting mechanism coupled with the collar body, wherein the at least one adjusting mechanism is configured for foldably extending at least one portion of the collar body based on at least one action receivable by the at least one adjusting mechanism, wherein the at least one adjusting mechanism is configured for modifying a length of the collar body defined between the first end and the second end based on the foldably extending.

14. The undercollar of claim 13, wherein the panel comprises a cutaway, wherein the cutaway forms the viewing portion, wherein the at least one portion of the at least one identification tag is viewable through the cutaway.

15. The undercollar of claim 13, wherein the panel comprises a transparent portion forming the viewing portion, wherein the transparent portion comprises at least one transparent material.

16. The undercollar of claim 13, wherein the at least one material comprises at least one of at least one stretchable material, at least one flexible material, and at least one soft material, wherein the at least one of the at least one stretchable material, the at least one flexible material, and the at least one soft material provides comfort to the at least one part of the body of the animal.

17. The undercollar of claim 13, wherein the collar body comprises at least one reflective portion, wherein the at least one reflective portion comprises at least one reflective material, wherein the at least one reflective portion is configured for making the collar body visible by reflecting light.

18. The undercollar of claim 13, wherein the first part of the at least one fastening element is configured to be detachably fastened to the second part of the at least one fastening element for detachably attaching the first portion to the second portion.

19. The undercollar of claim 13, wherein the first part of the at least one fastening element is configured to be fixedly fastened to the second part of the at least one fastening element for fixedly attaching the first portion to the second portion.

20. The undercollar of claim 13, wherein the at least one fastening element comprises an attachment mechanism, wherein the attachment mechanism comprises at least one male stud and at least one female stud, wherein a male stud of the at least one male stud forms a hook and a female stud of the at least one female stud forms a loop, wherein the female stud is configured for removably receiving the male stud, wherein the at least one male stud is disposed on the first end and the at least one female stud is disposed on the second end, wherein the first end is configured to be detachably attached to the second end based on the removably receiving.
